(19) United States
(12) Patent Application Publication
(10) Pub. No.: US 2007/0171147 A1
(43) Pub. Date: Jul. 26, 2007

(54) Apparatus and method for representation gradation

(75) Inventor: Jin-gil Jeong, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/655,937

(22) Filed: Jan. 22, 2007

(30) Foreign Application Priority Data
Jan. 20, 2006 (KR) 10-2006-0006294

(51) Int. Cl. G09G 3/14

(52) U.S. Cl. 345/46

(57) ABSTRACT

An apparatus and method for representing gradation are provided. The apparatus for representing gradation comprises a diode which emits light with an intensity which is proportional to the current flowing therethrough, a gradation representation unit that is connected in series to the diode and includes a plurality of switches connected in parallel, and a gray controller which receives a video signal and turns on a number of switches corresponding to a gray level of the video signal.

### CROSS-REFERENCE TO RELATED PATENT APPLICATION

This application claims the priority from Korean Patent Application No. 10-2006-0006294, filed on Jan. 20, 2006, in the Korean Intellectual Property Office, the disclosure of which is incorporated herein in its entirety by reference.

### BACKGROUND OF THE INVENTION

1. Field of the Invention

The present invention relates to an apparatus and method for representing gradation using a diode.

2. Description of the Related Art

Laser diodes and light-emitting diodes are used as small light sources in laser pointers, compact disc (CD) players, digital versatile disc (DVD) players, bar code readers and other electro-optical devices. When laser diodes and light-emitting diodes are used for display devices or medical apparatus, their output power must be appropriately controlled.

FIG. 1 illustrates the configuration of a related art apparatus for representing gradation using a diode. Referring to FIG. 1, a power supply circuit 100 is connected to the input terminal of a laser diode 110 and provides a current to the laser diode 110. The current flowing through the laser diode 110 is controlled by a metal oxide semiconductor field effect transistor (MOSFET) 125, which varies the current in proportion to the voltage of a digital/analog converter (DAC) output 120. The gradation of light emitted from the laser diode 110 depends on the current flowing through the laser diode 110.

However, the related art apparatus for representing gradation is vulnerable to noise because it is sensitive to the voltage applied to the MOSFET. Furthermore, the related art apparatus cannot instantaneously vary the current flowing through the MOSFET, and thus is slow to change gradation.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides an apparatus and method for representing gradation rapidly and correctly by controlling a current flowing through a diode using switches connected in parallel.

According to an aspect of the present invention, there is provided a method of representing gradation comprising: applying a predetermined voltage to the input terminal of a diode; receiving a video signal and generating a gray level of the video signal; and turning on a number of switches corresponding to the gray level, among a plurality of switches connected in parallel and connected in series with the diode.

According to another aspect of the present invention, there is provided an apparatus for representing gradation comprising: a diode emitting light with an intensity in proportion to the current flowing therethrough; a gradation representation unit including a plurality of switches connected in parallel and connected in series to the diode; and a gray controller receiving a video signal and turning on a number of switches corresponding to the gray level of the video signal.

A heat sink unit may be connected to the diode and to cool the diode to maintain the diode below a uniform temperature.

The maintaining the diode a uniform temperature may include cooling the diode below a predetermined temperature.

The gradation representation unit may include at least one offset transistor that passes an offset current of the diode.

The gray controller may turn on the offset transistor even when the gray level of the video signal is 0.

The number of switches included in the gradation representation unit may be larger than the number of gray levels that can be represented using light emitted from the diode.

The plurality of switches included in the gradation representation unit may be transistors of equal standard.

The gradation representation unit may include resistors respectively connected in series with the plurality of switches.

The gray controller may divide the received video signal into R, G and B signals, generate gray levels of the R, G and B signals, and turn on a number of switches corresponding to the gray levels of the R, G and B signals.

The plurality of transistors of the gradation representation unit may include at least one field effect transistor.

The gradation representation unit may further include a heat sink that is connected to the diode and to cool the diode.

The gradation representation unit may include a plurality of operational amplifiers amplifying a differential voltage across two input terminals thereof, and a reference voltage unit applying a predetermined reference voltage to one of the two input terminals of each operational amplifier. Output terminals of the operational amplifiers may be respectively connected to the gates of the plurality of transistors, and the other one of the two input terminals of each operational amplifier is connected to the gray controller.

The turning on of the switches turns on at least one of the switches to pass the offset current of the diode.

The passing of the offset current of the diode turns on at least one of the switches to pass the offset current of the diode even when the gray level of the video signal is 0.

The turning on of the switches passes currents corresponding to resistors connected in series with the switches.

The generating of the gray levels divides the received video signal into R, G and B signals and generates gray levels of the R, G and B signals. The turning on of the switches turns on a number of switches corresponding to the gray levels of the R, G and B signals.

The method of representing gradation may further include cooling the diode.

The method of representing gradation may be stored as a program executed on a computer in a computer readable recording medium.

### BRIEF DESCRIPTION OF THE DRAWINGS

The above and other aspects of the present invention will become more apparent by describing in detail exemplary embodiments thereof with reference to the attached drawings in which:

FIG. 1 illustrates the configuration of a related art apparatus for representing gradation using a diode;

FIG. 2 illustrates the configuration of an apparatus for representing gradation according to an exemplary embodiment of the present invention;

FIG. 3 is a block diagram of the apparatus for representing gradation of FIG. 2 according to an exemplary embodiment of the present invention;

FIG. 4 is a flow chart showing a method of representing gradation according to an exemplary embodiment of the present invention;

FIG. 5 is a flow chart showing the method of representing gradation in more detail according to an exemplary embodiment of the present invention; and

FIG. 6 is a graph showing the relationship between optical output power and current through a laser diode.

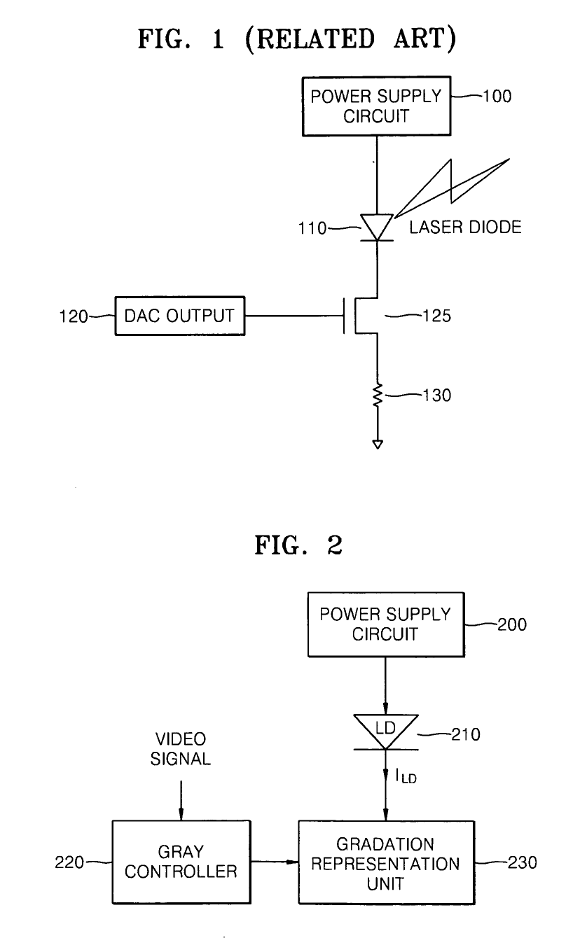

### DETAILED DESCRIPTION OF EXEMPLARY EMBODIMENTS OF THE INVENTION

The present invention will now be described more fully with reference to the accompanying drawings, in which exemplary embodiments of the invention are shown. The invention may, however, be embodied in many different forms, and should not be construed as being limited to the embodiments set forth herein; rather, these embodiments are provided so that this disclosure will be thorough and complete, and will fully convey the concept of the invention to those skilled in the art. Throughout the drawings, like reference numerals refer to like elements.

Luminescence generated when a voltage is applied to a semiconductor is referred to as electroluminescence. Materials suitable for a light-emitting diode should satisfy the conditions that their luminescent wavelength exists in the visible or near infrared range, their luminescent efficiency is high, and they can form a PN junction. two-element or three-element compound semiconductors belonging to IIIA and VA groups, such as GaAs, GaP, GaAs₁₋ₓPₓ, Ga₁₋ₓAlₓAs, InP and In₁₋ₓGaₓP, are used for the light-emitting diode. Studies on compounds belonging to IIB, VIB, IVA and IVB groups are being carried out.

Luminescence mechanisms usually involve either recombination of free carriers or recombination at the luminescent center of an impurity. The luminescent wavelength of a luminescence mechanism using the recombination of free carriers is approximately equal to ch/Eg, where c is the velocity of light, h is Planck's constant, and Eg is the energy width of the forbidden band. In the case of GaAs, the luminescent wavelength is approximately 900 nm, which corresponds to near infrared rays. In the case of GaAsP, Eg increases as the P content of the GaAsP increases, until visible rays are emitted.

The luminescence wavelength of the luminescence mechanism using the recombination at the luminescent center of an impurity depends on the kind of impurity doped into a semiconductor. In the case of GaP, luminescence involving zinc and oxide atoms generates red light (light having a wavelength of approximately 700 nm), and luminescence involving nitrogen atoms generates green light (light having a wavelength of approximately 550 nm).

A light-emitting diode is small and has a long life span. It also has a low power consumption and high efficiency, because it directly converts electrical energy into optical energy. Moreover, a light-emitting diode has a high response speed, and thus it is used for displays of vehicle dashboards, light sources for optical communications, display lamps of various electronic devices, numeral display devices, card readers, and so on. An injection type semiconductor laser is a kind of light-emitting diode having a very high injection density. In an injection type semiconductor laser, population inversion occurs to generate coherent light.

A laser diode generates laser light using a forward semiconductor junction as an active medium. The laser diode is called an injection type diode or a semiconductor laser diode and uses GaAs as its semiconducting material. Furthermore, the laser diode can emit various wavelengths (ultraviolet rays, visible rays and infrared rays).

A PN junction, a quantum well or a superlattice structure is used as an active layer structure of the laser diode, and IIIB and VB compounds such as AlGaAs and GaN are used as materials of the active layer of the laser diode.

The laser diode has been used in a restricted application field including optical communications and laser printers. However, the application field of the laser diode is being extended to display devices, lighting, and special light sources with specific wavelengths. Furthermore, the world market for laser diodes is expected to grow along with optical communication markets.

Diodes are used in a wide range of fields including communication, storage and recording devices, and medicine. As the demand for high speed Internet and high quality service increases, so does the development of large capacity data storage.

Exemplary embodiments of the present invention will now be explained with reference to attached drawings.

FIG. 2 illustrates the configuration of an apparatus for representing gradation according to an exemplary embodiment of the present invention. Referring to FIG. 2, a power supply circuit 200 applies a predetermined voltage to a diode 210 uniformly. The power supply circuit 200 may comprise a DC voltage source.

The diode 210 is connected in series with the power supply circuit 200, and emits light with an intensity proportional to the current flowing through the diode 210. The diode 210 may be a laser diode or a light-emitting diode.

A gradation representation unit 230 includes a plurality of switches connected in parallel to each other and connected in series with the diode 210. The gradation representation unit 230 controls the current flowing through the diode 210 in a digital rather than analog manner. That is, the current flowing through the diode 210 is discrete with respect to time. The plurality of switches included in the gradation representation unit 230 may be transistors.

A gray controller 220 receives a video signal and generates gray levels of the video signal. The gray controller 220 turns on a number of switches corresponding to the gray levels of the video signal. The gray controller 220 applies predetermined voltages to the plurality of transistors in the gradation representation unit 230, to turn on the transistors. Here, the predetermined voltages correspond to the threshold voltages of the transistors.

The gray controller 220 may include a signal input unit for receiving the video signal, a gray level calculating unit for calculating the gray level of the video signal, and a voltage application unit for applying a voltage to transistors in response to the gray level. The gray controller 220 may be implemented in firmware.

For example, when the video signal has 11 gray levels, at least 11 transistors included in the gradation representation unit 230 are turned on. The total current Id flowing through all the transistors corresponds to the current that can pass through the 11 transistors, because the transistors are connected in parallel. This current flows through the diode 210, and thus determines the gradation of light emitted from the diode 210.

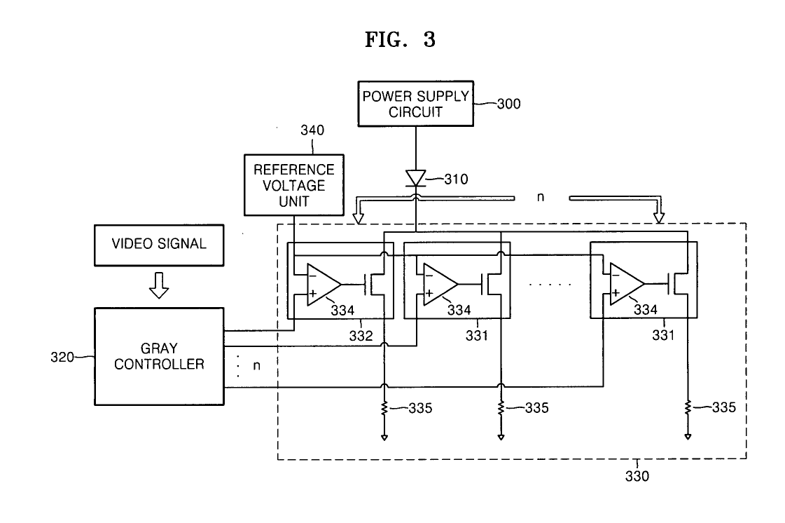

FIG. 3 is a block diagram of the apparatus for representing gradation of FIG. 2. Referring to FIG. 3, a power supply circuit 300 applies a predetermined voltage to a diode 310. The power supply circuit 300 may include a DC voltage source.

The diode 310 is connected in series with the power supply circuit 300 and emits light with an intensity corresponding to the current flowing through the diode 310. The diode 310 may be a laser diode or a light-emitting diode.

The apparatus for representing gradation can further include a heat sink unit (not shown) connected to the diode 310 to cool the diode 310. The heat sink unit may include a heat-radiating plate attached to the diode 310 and be possibly a cooler attached to the heat-radiating plate. The heat sink unit prevents the diode 310 from overheating.

The gradation representation unit 330 includes a plurality of transistors connected in parallel to each other and connected in series with the diode 310. While the plurality of transistors in FIG. 3 are field effect transistors, they can be bipolar junction transistors for rapid current control. The gradation representation unit 330 includes an offset transistor 332 which passes an offset current of the diode 310. That is, the plurality of transistors can be divided into gradation representation transistors 331 and the offset transistor 332. The number of gradation representation transistors 331 corresponds to the number of gray levels that those who are skilled in the art intend to produce using the diode 310. The plurality of transistors can be of equal standard.

The gradation representation unit 330 comprises a plurality of resistors 335 respectively connected to the transistors 331 and 332. The resistors 335 determine the current flowing through those transistors that are turned on.

The gradation representation unit 330 may further include a plurality of operational amplifiers 334, which amplify a differential voltage across two input terminals. The output terminals of the operational amplifiers 334 are respectively connected to the gates of the plurality of transistors (or the bases of the transistors when the transistors are bipolar junction transistors). One of the two input terminals of each operational amplifier 334 is connected to the gray controller 320.

The apparatus for representing gradation according to the exemplary embodiment of the present invention may further include a reference voltage unit 340 to apply a predetermined reference voltage to one of the two input terminals of each operational amplifier 334. The operational amplifiers 334 and the reference voltage unit 340 are used to transfer only an on/off signal from the gray controller 320 to the gates of the transistors (or the bases of the transistors when the transistors are bipolar junction transistors). That is, the operational amplifiers 334 amplify the differences between voltages transferred from the gray controller 320 and the reference voltage supplied by the reference voltage unit 340 to output voltages required for turning the transistors on and off.

The gray controller 320 receives a video signal and generates gray levels of the video signal. The gray controller 320 respectively applies predetermined voltages to the number of transistors corresponding to the number of gray levels of the video signal, to turn on the transistors. The gray controller 320 turns on the offset transistor 332 even when the gray level of the video signal is 0.

The gray controller 320 can divide the received video signal into R, G and B signals, generate gray levels of the R, G and B signals, and turn on a number of transistors corresponding to the gray levels of the R, G and B signals. Accordingly, gradation of a color image can be represented rapidly and correctly when the apparatus for representing gradation of the present invention is applied to a projection system such as a television (TV) set.

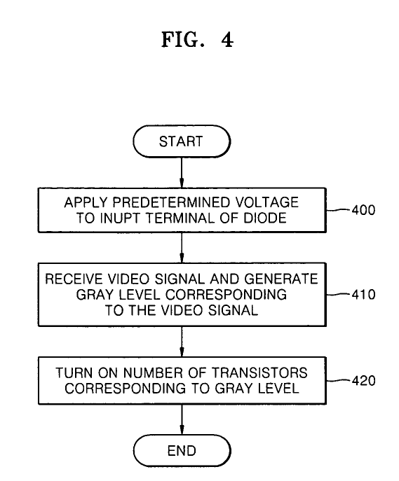

FIG. 4 is a flow chart showing a method of representing gradation according to an exemplary embodiment of the present invention. Referring to FIG. 4, a predetermined voltage is uniformly applied to the input terminal of a diode in operation 400. Here, the predetermined voltage is higher than the bias voltage which allows an offset current to flow through the diode.

Then, a video signal is received and gray levels corresponding to the video signal are generated in operation 410. Finally, a number of switches corresponding to the gray level of the video signal are turned on in operation 420. The plurality of switches may be transistors. In this case, predetermined voltages may be respectively applied to the plurality of transistors to turn on the transistors. The predetermined voltages correspond to the threshold voltages of the transistors.

For example, when the number of the gray levels of the video signal is 12, at least 12 transistors are turned on. Here, the total current flowing through the plurality of transistors corresponds to the current that can pass through the 12 transistors, because the transistors are connected in parallel. This current flows through the diode, and the light emitted from the diode determines the gradation.

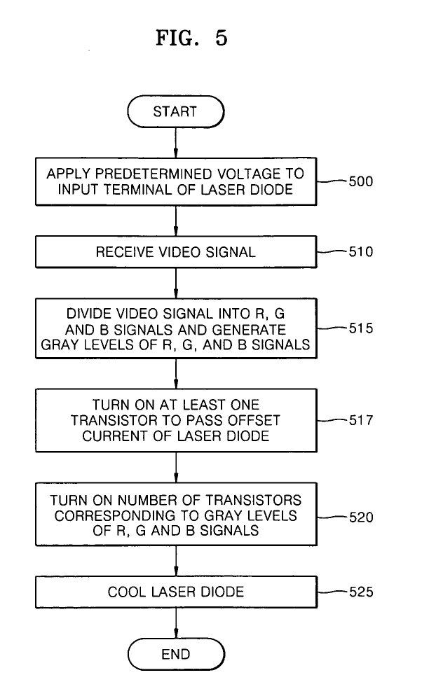

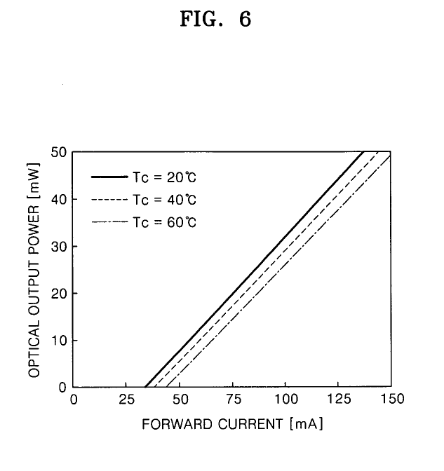

FIG. 5 is a flow chart showing the method of representing gradation in more detail according to an exemplary embodiment of the present invention. Referring to FIG. 5, a predetermined voltage is applied to the input terminal of a laser diode uniformly in operation 500. Here, the predetermined voltage is higher than the bias voltage which allows an offset current to flow through the laser diode. Then, a video signal is received in operation 510. The video signal is divided into R, G and B signals, and gray levels of the R, G and B signals are generated in operation 515.

Then, at least one of transistors connected in series with the laser diode is turned on to pass the offset current of the laser diode in operation 517. This is required to make the laser diode begin conducting, even when the gray level of the video signal is 0.

Subsequently, a number of transistors corresponding to the gray levels of the R, G and B signals are turned on in operation 520. Accordingly, a color image corresponding to the video signal can be displayed on the screen of a projection system. The current flowing through the turned on transistors is determined by resistors connected in series with the transistors.

Finally, the laser diode is cooled in operation 525. Laser diodes and light-emitting diodes emit light and heat in response to the current flowing therethrough. If the heat accumulates in the laser diode or light-emitting diode, operating characteristics can change. Accordingly, the laser diode must be cooled for stable operation.

FIG. 6 is a graph showing the relationship between optical output power and current through a laser diode. Referring to FIG. 6, the optical output power of the laser diode is proportional to the current flowing through the laser diode. A light-emitting diode has similar optical output power characteristics. Accordingly, an increase or decrease of the optical output power of the diode can correspond to a transistor switching on or off.

Furthermore, the optical output power varies with temperature, as illustrated in FIG. 6, and thus a constant temperature must be maintained.

The gradation representing method of the present invention may be stored in a computer readable recording medium to comprise a program executed in a computer.

As described above, according to an exemplary embodiment of the present invention, the current flowing through the diode is controlled using switches connected in parallel, and thus gradation representation can be rapid, correct, and robust to noise.

The present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. An apparatus for representing gradation, the apparatus comprising:
a diode emitting light which has an intensity which is proportional to a current flowing therethrough;
a gradation representation unit which includes a plurality of switches connected in parallel to each other and connected in series to the diode; and
a gray controller which receives a video signal and turns on a number of the switches corresponding to a gray level of the video signal.

2. The apparatus for claim 1, wherein the plurality of switches comprise transistors.

3. The apparatus for claim 2, wherein the transistors are of equal standard and pass equal currents when turned on.

4. The apparatus for claim 2, wherein at least one of the transistors is a field effect transistor.

5. The apparatus for claim 2, wherein the gradation representation unit comprises:
a plurality of operational amplifiers which amplify a differential voltage applied across two input terminals of each of the operational amplifiers; and
a reference voltage unit which applies a reference voltage to one of the two input terminals of each operational amplifier,
wherein output terminals of the operational amplifiers are respectively connected to gates of the plurality of transistors, and the other one of the two input terminals of each operational amplifier is connected to the gray controller.

6. The apparatus for claim 2, wherein the gradation representation unit comprises at least one offset transistor that passes an offset current of the diode.

7. The apparatus for claim 6, wherein the gray controller turns on the offset transistor if the gray level of the video signal is 0.

8. The apparatus for claim 2, wherein the gray controller applies voltages to a number of the transistors corresponding to the gray level of the video signal, to turn on the transistors.

9. The apparatus for claim 1, wherein the number of switches included in the gradation representation unit is larger than the number of gray levels that can be represented by the light emitted from the diode.

10. The apparatus for claim 1, wherein the gradation representation unit comprises resistors respectively connected in series to the plurality of switches.

11. The apparatus for claim 1, wherein the gray controller divides the received video signal into R, G and B signals, generates gray levels of the R, G and B signals, and turns on a number of the switches corresponding to the gray levels of the R, G and B signals.

12. The apparatus for claim 1, further comprising a heat sink unit for cooling the diode.

13. A method of representing gradation, the method comprising:
applying a voltage to an input terminal of a diode;
receiving a video signal and generating a gray level corresponding to the video signal; and
turning on a number of switches corresponding to the gray level, from among a plurality of switches connected in parallel to each other and connected in series to the diode.

14. The method of claim 13, wherein the turning on of the switches turns on at least one of the switches to pass an offset current of the diode.

15. The method of claim 14, wherein the passing of the offset current of the diode turns on at least one of the switches to pass the offset current of the diode if the gray level of the video signal is 0.

16. The method of claim 13, wherein the turning on of the switches passes current corresponding to resistors connected in series to the switches.

17. The method of claim 13, wherein the generating of the gray levels divides the received video signal into R, G and B signals and generates gray levels of the R, G and B signals, and the turning on the switches turns on a number of the switches corresponding to the gray levels of the R, G and B signals.

18. The method of claim 13, further comprising cooling the diode.
